(19) United States
(12) Patent Application Publication
(10) Pub. No.: US 2024/0265265 A1
(43) Pub. Date: Aug. 8, 2024

(54) METHOD FOR PARAMETER ADJUSTMENT OF REINFORCEMENT LEARNING ALGORITHM

(71) Applicant: MakinaRocks Co., Ltd., Seoul (KR)

(72) Inventors: Minseop KIM, Seoul (KR); Songsub LEE, Seoul (KR); Taeho LEE, Seoul (KR)

(73) Assignee: MakinaRocks Co., Ltd., Seoul (KR)

(21) Appl. No.: 18/429,667

(22) Filed: Feb. 1, 2024

(30) Foreign Application Priority Data
Feb. 2, 2023 (KR) 10-2023-0014321

(51) Int. Cl. G06N 3/092

(52) U.S. Cl. CPC G06N 3/092

(57) ABSTRACT

Disclosed is a method for adjusting a parameter of a reinforcement learning algorithm, is performed by a computing device. Specifically, according to the present disclosure, the computing device extracts at least some of episodes of the reinforcement learning algorithm, determines a complexity of a task performed by the reinforcement learning algorithm based on at least some episodes, and adjusts a parameter of the reinforcement learning algorithm based on the complexity.

### CROSS-REFERENCE TO RELATED APPLICATIONS

This application claims priority to and the benefit of Korean Patent Application No. 10-2023-0014321 in the Korean Intellectual Property Office on Feb. 2, 2023, the entire contents of which are incorporated herein by reference.

### TECHNICAL FIELD

The present disclosure relates to a method for parameter adjustment of a reinforcement learning algorithm, and more particularly, to a method for determining a complexity of a task performed by a reinforcement learning algorithm based on at least some episodes of the reinforcement learning algorithm, and adjusting a parameter of the reinforcement learning algorithm based on the complexity.

### BACKGROUND ART

Reinforcement learning is a learning method in which an agent defined in an environment receives a current state as an input and selects a possible action based on a reward.

For learning of a reinforcement learning algorithm, both elements, exploitation and exploration must be considered, so the exploitation means that the agent performs an optimal action using a result learned up to now, and the exploration is that the agent makes a new a try even though the agent does not perform an optimal action in order to gain various experiences.

In order to effectively design the exploration of the reinforcement learning, parameters for the exploration of the reinforcement learning algorithm must be appropriately adjusted, so in the related art, the adjustment of the parameters is mainly done by adjusting the characteristics of the algorithm and the characteristics of the task to be performed by the algorithm by algorithm developers. However, such a method contains unstable elements by relying on the developer's experience and intuition, and a problem with poor adaptability arise when a new type of task must be performed.

Therefore, there is a demand in the industry for a method for automatically adjusting parameters based on the characteristics of the reinforcement learning algorithm and the task.

Korea Patent Registration No. 2281118 discloses a 7-axis robot control method using reinforcement learning.

### SUMMARY OF THE INVENTION

The present disclosure is contrived in response to the above-described background art, and has been made in an effort to determine, by a computing device, a complexity of a task performed by a reinforcement learning algorithm based on at least some episodes of the reinforcement learning algorithm, and adjust a parameter of the reinforcement learning algorithm based on the complexity.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method for adjusting a parameter of a reinforcement learning algorithm, is performed by a computing device. The method may include: extracting at least some of the episodes of the reinforcement learning algorithm; determining a complexity of a task performed by the reinforcement learning algorithm based on at least some episodes; and adjusting a parameter of the reinforcement learning algorithm based on the complexity.

In an exemplary embodiment, the parameter may include a parameter related to exploration of the reinforcement learning algorithm.

In an exemplary embodiment, the extracting of at least some of the episodes of the reinforcement learning algorithm may include selecting at least some of the episodes of the reinforcement learning algorithm using one or more algorithms.

In an exemplary embodiment, the one or more algorithms may include at least one of random sampling or one or more meta-heuristic algorithms.

In an exemplary embodiment, the determining of the complexity of the task performed by the reinforcement learning algorithm based on at least some episodes may include identifying an action set constituting at least some episodes, computing a value related to a statistical amount representing the action set, and determining the complexity based on the value related to the statistical amount.

In an exemplary embodiment, the value related to the statistical amount may include at least one of an entropy for the action set, or a ratio of the number of effective dimensions to the number of action space dimensions for the action set.

In an exemplary embodiment, the determining of the complexity based on the value related to the statistical amount may include determining that the complexity is high as the entropy becomes larger when the value related to the statistical amount is the entropy for the action set, and determining, when the value related to the statistical amount is a ratio of the number effective dimensions to the number of action space dimensions for the action set, that the complexity is high as the ratio becomes larger.

In an exemplary embodiment, the number of effective dimensions may be determined based on a variance of a result value of performing singular value decomposition for at least some episodes.

In an exemplary embodiment, the adjusting of the parameter of the reinforcement learning algorithm based on the complexity may include identifying the type of reinforcement learning algorithm, and adjusting the parameter of the reinforcement learning algorithm based on the type and the complexity.

In an exemplary embodiment, the adjusting of the parameter of the reinforcement learning algorithm based on the type and the complexity may include setting an entropy lower bound of the reinforcement learning algorithm to be high as the complexity becomes higher when the type of reinforcement learning algorithm is soft actor-critic.

In an exemplary embodiment, the adjusting of the parameter of the reinforcement learning algorithm based on the type and the complexity may include setting an entropy coefficient of the reinforcement learning algorithm to be high as the complexity becomes higher when the type of reinforcement learning algorithm is proximal policy optimization.

In an exemplary embodiment, the adjusting of the parameter of the reinforcement learning algorithm based on the type and the complexity may include setting, when the type of reinforcement learning algorithm is deep deterministic policy gradient, a coefficient of a Wiener process among a standard deviation of Gaussian noise or Ornstein-Uhlenbeck noise of the reinforcement learning algorithm to be high as the complexity becomes higher.

In an exemplary embodiment, the adjusting of the parameter of the reinforcement learning algorithm based on the type and the complexity may include setting the entropy coefficient of the reinforcement learning algorithm to be high as the complexity becomes higher when the type of reinforcement learning algorithm is Advantage Actor-Critic or Asynchronous Advantage Actor-Critic.

In an exemplary embodiment, the adjusting of the parameter of the reinforcement learning algorithm based on the type and the complexity may include setting an epsilon value of the reinforcement learning algorithm to be high as the complexity becomes higher when the type of reinforcement learning algorithm is Deep Q Network.

In an exemplary embodiment, the adjusting of the parameter of the reinforcement learning algorithm based on the type and the complexity may include setting a Gaussian noise value of the reinforcement learning algorithm to be high as the complexity becomes higher when the type of reinforcement learning algorithm is Twin Delayed Deep Deterministic Policy Gradient.

In an exemplary embodiment, the adjusting of the parameter of the reinforcement learning algorithm based on the type and the complexity may include setting the Gaussian noise value of the reinforcement learning algorithm to be high as the complexity becomes higher when the type of reinforcement learning algorithm is Importance Weighted Actor-Learner Architecture.

In an exemplary embodiment, the method may further include performing the task by using the reinforcement learning algorithm based on the parameter.

Another exemplary embodiment of the present disclosure provides a computer program which allows a computing device to perform operations for adjusting a parameter of a reinforcement learning algorithm. The operations may include: an operation of extracting at least some of the episodes of the reinforcement learning algorithm; an operation of determining a complexity of a task performed by the reinforcement learning algorithm based on at least some episodes; and an operation of adjusting a parameter of the reinforcement learning algorithm based on the complexity.

Yet another exemplary embodiment of the present disclosure provides a computing device for adjusting of a parameter of a reinforcement learning algorithm. The computing device may include a processor comprising one or more cores; and a memory, and the processor may be configured to extract at least some of the episodes of a reinforcement learning algorithm, determine a complexity of a task performed by the reinforcement learning algorithm based on at least some episodes; and adjust a parameter of the reinforcement learning algorithm based on the complexity.

According to an exemplary embodiment of the present disclosure, there is an effect of increasing learning efficiency of a reinforcement learning algorithm. For example, according to an exemplary embodiment of the present disclosure, the complexity of a task performed by the reinforcement learning algorithm is determined based on at least some episodes extracted from the reinforcement learning algorithm, and a parameter of the reinforcement learning algorithm is determined based on the complexity to more efficiently perform exploration of the reinforcement learning algorithm.

### BRIEF DESCRIPTION OF THE DRAWINGS

FIG. 1 is a block diagram of a computing device for providing a development environment according to an exemplary embodiment of the present disclosure.

FIG. 2 is a schematic view illustrating a network function according to an exemplary embodiment of the present disclosure.

FIG. 3 is a conceptual view illustrating a reinforcement learning algorithm according to an exemplary embodiment of the present disclosure.

FIG. 4 is a flowchart illustrating a process of adjusting a parameter of a reinforcement learning algorithm according to an exemplary embodiment of the present disclosure.

FIG. 5 is a conceptual view illustrating an episode and an action of the reinforcement learning algorithm according to an exemplary embodiment of the present disclosure.

FIG. 6 is a conceptual view illustrating a process of adjusting a parameter of the reinforcement learning algorithm according to an exemplary embodiment of the present disclosure.

FIG. 7 is a simple and normal schematic view of an exemplary computing environment in which the exemplary embodiments of the present disclosure may be implemented.

### DETAILED DESCRIPTION

The present disclosure provides a method for determining a complexity of a task performed by a reinforcement learning algorithm based on at least some episodes of the reinforcement learning algorithm, and adjusting a parameter of the reinforcement learning algorithm based on the complexity.

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or”. That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, exploration as a term used in the field of reinforcement learning may refer to a process of attempting, by an agent, different actions in an environment to collect information, improve a policy, and maximize a reward. The exploration is an opposite concept to exploitation, which may mean that the agent relies on current knowledge and performs an action of believing that a highest reward is obtained. The balance between the exploration and the exploitation may be a key element for properly building a reinforcement learning algorithm, and several algorithms for performing the exploration and the exploitation are known to those skilled in the art.

In the present disclosure, an episode may refer to a scenario of a periodic action performed in the environment by the agent. In other words, an episode may refer to a set of results in which the agent observes a state, performs an action therefor, and receives the reward. In general, each episode may provide information to improve the policy of the agent.

In the present disclosure, a parameter may refer to a variable that may determine characteristics of the policy of the reinforcement learning algorithm. Specifically, the parameter may refer to a variable that may be adjusted during an exploration process of reinforcement learning. The parameter of the reinforcement learning algorithm of the present disclosure may have a specific initial value, and the initial value of the parameter may be changed later.

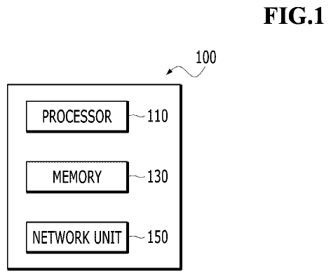

FIG. 1 is a block diagram of a computing device for providing a development environment according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like.

At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

The processor 110 may extract at least some of the episodes of the agent from the reinforcement learning algorithm. For example, when 20 episodes are performed by the agent of the reinforcement learning algorithm, the processor 110 may extract 10 episodes out of a total of 20 episodes.

One or more algorithms may be used for the processor 110 to extract at least some of the episodes of the reinforcement learning, so the algorithm for extracting the episode may adopt a meta-heuristic algorithm, including random sampling, simulated annealing, or a genetic algorithm. However, the algorithm for extracting the episode is not limited to the above example, and in the present disclosure, other exemplarily unmentioned algorithms may be used for extracting the episode.

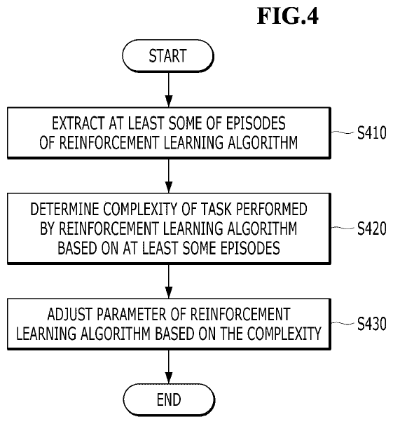

The processor 110 may determine the complexity of the task performed by the reinforcement learning algorithm based on at least some episodes extracted from the reinforcement learning algorithm. In the present disclosure, the complexity may refer to difficulty of a reinforcement learning problem. The complexity of the task may vary depending on the complexity of the environment, the number of actions the agent must perform, and the complexity of a reward function. In general, a task with high complexity makes it more difficult for the agent to find an optimal policy. A specific method by which the processor 110 determines the complexity of the task performed by the reinforcement learning algorithm will be described later with reference to FIG. 4.

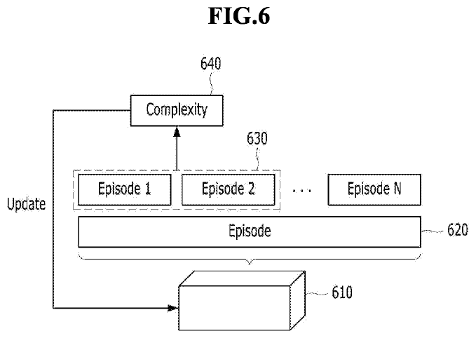

The processor 110 may adjust the parameter of the reinforcement learning algorithm based on the determined complexity. At this time, the processor 110 may use information on the type of reinforcement learning for adjusting the parameter. In the present disclosure, the parameter of the reinforcement learning algorithm may refer to a parameter included during an exploration process of the reinforcement learning algorithm. For example, when the type of reinforcement learning algorithm is soft-actor-critic (SAC), the greater the determined complexity, the processor 110 may set a lower bound of entropy in a policy used in the exploration process of the algorithm to be high. Other exemplary embodiments of adjusting the parameter of the reinforcement learning will be described later with reference to FIG. 6.

The processor 110 may perform the task by using the reinforcement learning algorithm based on the parameter set according to the complexity. In the present disclosure, the parameter of the reinforcement learning algorithm for performing the task is determined by a numerical value called quantitatively calculated complexity with respect to the task rather than the engineer's intuition. As a result, through the present disclosure, repetitive execution for optimizing the reinforcement learning algorithm may be dramatically reduced, and computing resources and time for developing a high-performance reinforcement learning algorithm may be saved.

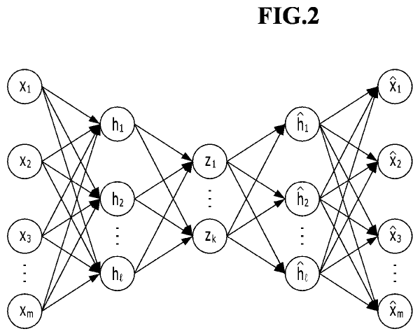

FIG. 2 is a schematic diagram illustrating a network function according to the embodiment of the present disclosure.

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the embodiment of the present disclosure, the number of nodes of the input layer may be the same as the number of nodes of the output layer, and the neural network may be in the form that the number of nodes decreases and then increases again from the input layer to the hidden layer. Further, in the neural network according to another embodiment of the present disclosure, the number of nodes of the input layer may be smaller than the number of nodes of the output layer, and the neural network may be in the form that the number of nodes decreases from the input layer to the hidden layer. Further, in the neural network according to another embodiment of the present disclosure, the number of nodes of the input layer may be larger than the number of nodes of the output layer, and the neural network may be in the form that the number of nodes increases from the input layer to the hidden layer. The neural network according to another embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

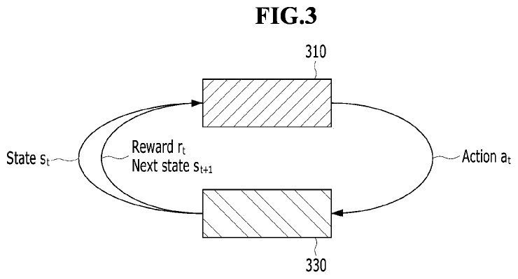

FIG. 3 is a conceptual view illustrating a reinforcement learning algorithm according to an exemplary embodiment of the present disclosure.

The reinforcement learning is a learning method which trains the neural network model based on a reward calculated for an action selected by the neural network model to allow the neural network model to determine a better action based on a state. The reinforcement learning is understood as learning through trial and error because the decision (that is, action) is rewarded. A reward given to the neural network model during the reinforcement learning process, may be a reward obtained by accumulating results of a plurality of actions. Reinforcement learning generates an artificial neural network model that learns to maximize the reward itself or the return (the sum of the rewards), given a number of states and a reward for an action. In the context of this disclosure, the term “reinforcement learning model” may be used interchangeably with the term “agent” as an entity that determines behavior. In the art related to reinforcement learning, the term “environment” (Env) or “environment model” is used to refer to a model that returns a result that takes into account the behavior of an agent. An environment model can be a model that returns output data (e.g., state information) for a given input data (e.g., control information). An environmental model can be a model structure for getting from input to output, or a model where the causal relationships between input and output data are unknown. The agent and the environment can operate by exchanging data.

The reinforcement learning control model 310 is a main agent which determines an active based on the state information and the reward and is understood as an agent. In the present disclosure, the state information includes current state information and next state information. The current state information and the next state information may be distinguished by a timing or an order that the corresponding state information is acquired and is referred to as current state information Sₜ and next state information Sₜ₊₁ based on the order.

In the present disclosure, the environment 330 may yield “current state information (Sₜ)” on which the reinforcement learning model 310 may base behavioral decisions. After obtaining the current state information (Sₜ), which may include at least one state variable, from the environment 330, the processor 110 may input the current state information into the reinforcement learning model 310.

In the present disclosure, after inputting the current state information into the reinforcement learning model 310, the processor 110 may calculate an action (Aₜ) based on the reinforcement learning model 310. The reinforcement learning model 310 may compute a probability distribution for a plurality of selectable behaviors based on the state information (Sₜ) obtained from the environment 330 at a random time t. The processor 110 may calculate an action (Aₜ) based on the calculated probability distribution. For example, the processor 110 may determine the largest value of the probability distribution over the plurality of behaviors as the behavior (Aₜ).

In the present disclosure, the processor 110 may input the behavior calculated based on the reinforcement learning model 310 into the environment 330. The processor 110 may obtain updated next state information (Sₜ₊₁) and a reward (Rₜ) from the environment 330 as a result of the input of the behavior. Reinforcement learning may be referred to as “model-based” reinforcement learning when the environment 330 knows the “reward function” on which the reward is based or the “transition probability distribution function” on which the environment 330 is based for determining the next state information after receiving the behavior from the reinforcement learning model 310. On the other hand, reinforcement learning when the reward function of the environment 330 and the transition probability distribution function of the environment 330 are unknown may be referred to as “model-free” reinforcement learning.

The reinforcement learning agent according to the present disclosure may be learned based on at least one episode. In the present disclosure, the “episode” may be used as a term meaning a data sequence having a series of orders. The episode may be a data set constituted by a plurality of E-tuple data including E (E is a natural number of 1 or more) elements. The plurality of E-tuple data included in the episode may have a series of orders. As an example related to the E-tuple data, when E is ‘4’, respective 4-tuple data may include current situation information, a control action at the current time point, a reward at the current time point, and next situation information as elements. As an example related to the E-tuple data, when E is ‘5’, respective 5-tuple data may also include current time point situation information, a control action at the current time point, a reward at the current time point, and next time point situation information, a control action at the next time point as elements.

The processor 110 according to the present disclosure may acquire one episode by repeatedly performing a plurality of steps of the above-described learning method from an initial state to a terminal state. The terminal state may be derived when a predetermined end condition is satisfied or when a predetermined number of steps are conducted. The step indicates at least one action unit in which the reinforcement learning control model receives a state and determines an action, and then receives a reward for the action or updated state information. The number of predetermined steps may be set to an arbitrary natural number, and may be constituted by, for example, 200 steps.

The processor 110 may train the reinforcement learning agent based on at least one learning data. As an example, the processor 110 may train the reinforcement learning agent based on the learning data corresponding to each step each time each step ends. In another example, the processor 110 may train the reinforcement learning model based on a training data set that includes training data for each of the plurality of steps at the end of each episode that includes the plurality of steps. In another example, the processor 110 may train a reinforcement learning model based on a training data set including training data for each of the steps after a predetermined batch size of steps has been performed. The batch size may be predetermined as any natural number.

The process in which the processor 110 performs the reinforcement learning according to the present disclosure may include a step of modifying each node weight or bias value of a neural network included in the reinforcement learning agent. The step of modifying each node weight or bias value of the neural network included in the reinforcement learning agent may be performed by the same or similar method as a backpropagation technique for the neural network described above with reference to FIG. 4 by the processor 110. For example, when the reward (Rₜ) included in the learning data for an arbitrary time point t is a positive number, the processor 110 may control weights or bias values of one or more nodes included in the reinforcement learning agent so that the control action (Aₜ) for the arbitrary time point t included in the learning data is reinforced. In this case, one or more nodes included in the reinforcement learning control model may be nodes which receives the situation information (Sₜ) included in the learning data for the arbitrary time point t as an input, and then involved in determining the control action (Aₜ).

Meanwhile the reinforcement learning agent 310 may determine the action in each state information so that a cumulative value (i.e., return) of the reward given from the environment 330 becomes maximum. A method for determining the action by the reinforcement learning agent 310 may be based on, for example, at least one of a value-based action determination method, a policy-based action determination method, and a both-value and policy-based action determination method. The value-based action determination method is a method for determining an action of giving a highest value in each state based on a value function. An example of the value-based action determination method may include Q-learning, deep Q-network (DQN), etc. The policy-based action determination method is a method for determining the action based on a final return and a policy function without the value function. An example of the policy-based action determination method may include a policy gradient technique, etc. The both-value and policy-based action determination method is a method for determining the action of the reinforcement learning agent by learning in a scheme in which when the policy function determines the action, the value function evaluates the action. The both-value and policy-based action determination method may include, for example, an Actor-Critic algorithm, a Soft Actor-Critic algorithm, an A2C algorithm, an A3C algorithm, and the like.

The specific descriptions regarding the learning of the reinforcement learning model are only for explanation and do not limit the present disclosure.

FIG. 4 is a flowchart illustrating a process of adjusting a parameter of a reinforcement learning algorithm according to an exemplary embodiment of the present disclosure.

According to FIG. 4, the process of adjusting the parameter of the reinforcement learning algorithm according to the present disclosure may include a step S410 of extracting at least some of episodes of the reinforcement learning algorithm, a step S420 of determining a complexity of a task performed by the reinforcement learning algorithm based on at least some episodes, and a step S430 of adjusting a parameter of the reinforcement learning algorithm based on the complexity.

In step S410, a processor 110 may extract at least some of the episodes of the reinforcement learning algorithm.

The processor 110 may select at least some of the episodes of the reinforcement learning algorithm in order to extract at least some episodes. For example, when one episode is constituted by 10 actions, and there are a total of 20 episodes, the processor 110 may select and analyze 5 episodes among 20 episodes in order to determine the complexity.

In step S420, the processor 110 may determine the complexity of the task performed by the reinforcement learning algorithm based on at least some episodes. In order to determine the complexity of the task, the processor 110 may identify an action set constituting the extracted episode. In general, the episode of the reinforcement learning algorithm may include a plurality of actions. For example, each episode may be a set of 10 actions generated while the reinforcement learning algorithm performs one scenario. Further, in this case, when the processor 110 extracts 5 episodes in order to determine the complexity of the task, 50 actions may be extracted.

In order to determine the complexity of the task, the processor 110 may compute the value related to a statistical amount representing the action set. In this case, the value related to the statistical amount may include an entropy for the action set, or a ratio of the number of effective dimensions to the number of action space dimensions for the action set. In this case, the number of effective dimensions for the action set may be determined based on a variance of result values of performing singular value decomposition for the action set.

The processor 110 may determine the complexity of the task performed by the reinforcement learning algorithm based on the value related to the statistical amount. For example, the processor 110 may determine that the complexity of the task becomes higher as the value of the statistical amount becomes larger while expressing the complexity as a real number type of 0 or more. Specifically, the processor 110 may determine that the complexity of the task becomes higher as the entropy of the action set becomes higher. As another example, the processor 110 may determine that the complexity of the task becomes higher as the ratio of the number of effective dimensions to the number of action space dimensions for the action set becomes higher.

In step S430, the processor 110 may adjust the parameter of the reinforcement learning algorithm based on the determined complexity. In this case, the processor may identify the type of reinforcement learning algorithm, and adjust the parameter of the reinforcement learning algorithm based on the type of reinforcement learning algorithm and the complexity of the task. Below, in the exemplary embodiment of the present disclosure, the parameter of the reinforcement learning algorithm may be set to have a specific initial value, so the reinforcement learning algorithm may generate an episode based on the initial value of the parameter. Thereafter, the processor 110 may determine the complexity of the task from the episode generated based on the initial value, and change the parameter of the reinforcement learning algorithm.

In an exemplary embodiment of the present disclosure, when the type of the reinforcement learning algorithm is soft actor-critic, the processor 110 sets an entropy lower bound of the reinforcement learning algorithm to be high as the complexity becomes higher to determine the parameter of the reinforcement leaning algorithm.

In an exemplary embodiment of the present disclosure, when the type of the reinforcement learning algorithm is proximal policy optimization, the processor 110 sets an entropy coefficient of the reinforcement learning algorithm to be high as the complexity becomes higher to determine the parameter of the reinforcement leaning algorithm.

In an exemplary embodiment of the present disclosure, when the type of reinforcement learning algorithm is deep deterministic policy gradient, the processor 110 sets a coefficient of a Wiener process among a standard deviation of Gaussian noise or Ornstein-Uhlenbeck noise of the reinforcement learning algorithm to be high as the complexity becomes higher to determine the parameter of the reinforcement learning algorithm.

In this case, the Ornstein-Uhlenbeck noise may be expressed in a form shown in [Equation 1].

$${dx}_{t} = - θ {x}_{t} dt + σ {dW}_{t} \qquad [ Equation 1 ]$$

The processor 110 may set σ which is a coefficient of a Wiener process W₁ in [Equation 1], and adjust the parameter of the reinforcement learning algorithm.

In an exemplary embodiment of the present disclosure, when the type of reinforcement learning algorithm is Advantage Actor-Critic or Asynchronous Advantage Actor-Critic, the processor 110 sets the entropy coefficient of the reinforcement learning algorithm to be high as the complexity becomes higher to determine the parameter of the reinforcement leaning algorithm.

In an exemplary embodiment of the present disclosure, when the type of reinforcement learning algorithm is deep Q network, the processor 110 sets an epsilon value of the reinforcement learning algorithm to be high as the complexity becomes higher to determine the parameter of the reinforcement leaning algorithm.

In an exemplary embodiment of the present disclosure, when the type of reinforcement learning algorithm is Twin Delayed Deep Deterministic Policy Gradient, the processor 110 sets a Gaussian noise value of the reinforcement learning algorithm to be high as the complexity becomes higher to determine the parameter of the reinforcement leaning algorithm.

In an exemplary embodiment of the present disclosure, when the type of reinforcement learning algorithm is Importance Weighted Actor-Learner Architecture, the processor 110 sets the Gaussian noise value of the reinforcement learning algorithm to be high as the complexity becomes higher to determine the parameter of the reinforcement leaning algorithm.

Reinforcement learning algorithms to which the method of the present disclosure may be applied and parameters that may be adjusted in respective reinforcement learning algorithms are exemplarily presented, but it is apparent to those skilled in that art that the present disclosure is not limited to the above-described examples and can be applied to various types of reinforcement learning algorithms in a similar manner.

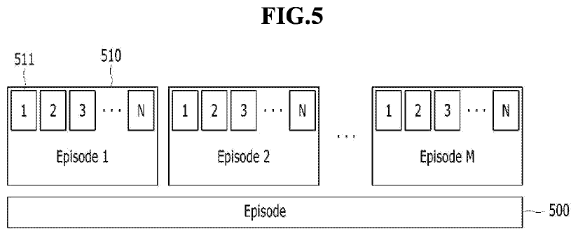

FIG. 5 is a conceptual view illustrating an episode and an action of the reinforcement learning algorithm according to an exemplary embodiment of the present disclosure.

When described with reference to FIG. 5, individual episodes 510 included in the plurality of episode sets 500 generated by the reinforcement learning algorithm may be a set constituted by a plurality of actions 511.

For example, when the reinforcement learning algorithm is applied to automatically control a robot arm for assembling a product, the agent may generate 10 control information, i.e., actions at a predetermined time interval up to a first action, a second action, a third action, . . . , an N-th action in order for the robot arm to produce one product. In this case, the 10 generated actions may be determined as a first episode of the reinforcement learning algorithm. Next, when the robot arm assembles five products of the same type, a first episode, a second episode, a third episode, . . . , an M-th episode may be generated by the reinforcement learning algorithm.

The processor 110 may extract at least some of the episodes, identify sets of actions included in the extracted episodes, and determine the complexity of the task based on the sets of the actions.

FIG. 6 is a conceptual view illustrating a process of adjusting a parameter of the reinforcement learning algorithm according to an exemplary embodiment of the present disclosure.

In FIG. 6, a plurality of episodes 620 may be generated by a reinforcement learning algorithm 610. At this time, the plurality of episodes 620 may be constituted by N episodes. The processor 110 may extract two episodes 620 out of N episodes. When extracting two episodes 620, the processor 110 may determine a complexity 640 of a task based on the set of actions included in two episodes. Thereafter, the processor 110 may adjust a parameter of the reinforcement learning algorithm 610 based on the complexity 640 of the task. At this time, the process of adjusting the parameter may be a process of updating an initial value of the parameter.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

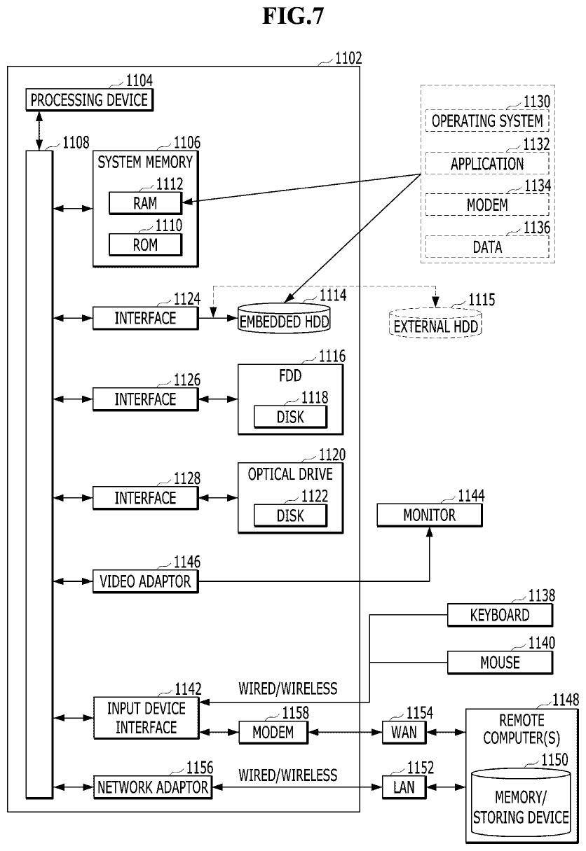

FIG. 7 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multiprocessor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method for adjusting a parameter of a reinforcement learning algorithm, the method performed by a computing device, the method comprising:
extracting at least some of episodes of the reinforcement learning algorithm;
determining a complexity which is an indicator that quantifies a difficulty of a task performed by the reinforcement learning algorithm based on the at least some of the episodes; and
adjusting a parameter of the reinforcement learning algorithm based on the complexity,
wherein the determining of the complexity includes:
identifying an action set constituting the at least some of the episodes,
computing a value related to a statistical amount that quantifies a degree at which actions included in the action set are distributed, and
determining the complexity based on the value related to the statistical amount.

2. The method of claim 1, wherein the parameter includes a parameter related to exploration of the reinforcement learning algorithm.

3. The method of claim 1, wherein the extracting of at least some of the episodes of the reinforcement learning algorithm includes:
selecting at least some of the episodes of the reinforcement learning algorithm using one or more algorithms.

4. The method of claim 3, wherein the one or more algorithms include at least one of:
a random sampling, or
one or more meta-heuristic algorithms.

5. The method of claim 1, wherein the value related to the statistical amount includes at least one of:
an entropy for the action set, or
a ratio of a number of effective dimensions to a number of action space dimensions for the action set.

6. The method of claim 5, wherein the determining of the complexity based on the value related to the statistical amount includes:
determining that the complexity is higher as the entropy becomes larger when the value related to the statistical amount is the entropy for the action set, and
determining, when the value related to the statistical amount is the ratio of the number effective dimensions to the number of action space dimensions for the action set, that the complexity is higher as the ratio becomes larger.

7. The method of claim 6, wherein the number of effective dimensions is determined based on a variance of a result value of performing singular value decomposition for at least some episodes.

8. The method of claim 1, wherein the adjusting of the parameter of the reinforcement learning algorithm based on the complexity includes:
identifying a type of the reinforcement learning algorithm, and
adjusting the parameter of the reinforcement learning algorithm based on the type and the complexity.

9. The method of claim 8, wherein the adjusting of the parameter of the reinforcement learning algorithm based on the type and the complexity includes:
setting an entropy lower bound of the reinforcement learning algorithm to be higher as the complexity becomes higher when the type of reinforcement learning algorithm is soft actor-critic.

10. The method of claim 8, wherein the adjusting of the parameter of the reinforcement learning algorithm based on the type and the complexity includes:
setting an entropy coefficient of the reinforcement learning algorithm to be higher as the complexity becomes higher when the type of reinforcement learning algorithm is proximal policy optimization.

11. The method of claim 8, wherein the adjusting of the parameter of the reinforcement learning algorithm based on the type and the complexity includes:
setting, when the type of reinforcement learning algorithm is deep deterministic policy gradient, a coefficient of a Wiener process among a standard deviation of Gaussian noise or Ornstein-Uhlenbeck noise of the reinforcement learning algorithm to be higher as the complexity becomes higher.

12. The method of claim 8, wherein the adjusting of the parameter of the reinforcement learning algorithm based on the type and the complexity includes:
setting an entropy coefficient of the reinforcement learning algorithm to be higher as the complexity becomes higher when the type of reinforcement learning algorithm is Advantage Actor-Critic or Asynchronous Advantage Actor-Critic.

13. The method of claim 8, wherein the adjusting of the parameter of the reinforcement learning algorithm based on the type and the complexity includes:
setting an epsilon value of the reinforcement learning algorithm to be high as the complexity becomes higher when the type of reinforcement learning algorithm is Deep Q Network.

14. The method of claim 8, wherein the adjusting of the parameter of the reinforcement learning algorithm based on the type and the complexity includes:
setting a Gaussian noise value of the reinforcement learning algorithm to be higher as the complexity becomes higher when the type of reinforcement learning algorithm is Twin Delayed Deep Deterministic Policy Gradient.

15. The method of claim 8, wherein the adjusting of the parameter of the reinforcement learning algorithm based on the type and the complexity includes:
setting a Gaussian noise value of the reinforcement learning algorithm to be higher as the complexity becomes higher when the type of reinforcement learning algorithm is Importance Weighted Actor-Learner Architecture.

16. The method of claim 1, further comprising:
performing the task by using the reinforcement learning algorithm based on the parameter.

17. A computer program stored in a non-transitory computer readable storage medium, the computer program causing a computing device to perform operations for adjusting a parameter of a reinforcement learning algorithm, the operations comprising:
an operation of extracting at least some of episodes of the reinforcement learning algorithm;
an operation of determining a complexity which is an indicator that quantifies a difficulty of a task performed by the reinforcement learning algorithm based on the at least some of the episodes; and
an operation of adjusting a parameter of the reinforcement learning algorithm based on the complexity,
wherein the operation of determining the complexity includes:
an operation of identifying an action set constituting the at least some of the episodes,
an operation of computing a value related to a statistical amount that quantifies a degree at which actions included in the action set are distributed, and
an operation of determining the complexity based on the value related to the statistical amount.

18. A computing device comprising:
a processor comprising one or more cores;
a network unit; and
a memory,
wherein the processor is configured to:
extract at least some of episodes of a reinforcement learning algorithm,
determine a complexity which is an indicator that quantifies a difficulty of a task performed by the reinforcement learning algorithm based on the at least some of the episodes,
adjust a parameter of the reinforcement learning algorithm based on the complexity, and
wherein the determining of the complexity includes:
identifying an action set constituting the at least some of the episodes,
computing a value related to a statistical amount that quantifies a degree at which actions included in the action set are distributed, and
determining the complexity based on the value related to the statistical amount.
